(19) United States
(12) Patent Application Publication
(10) Pub. No.: US 2025/0335809 A1
(43) Pub. Date: Oct. 30, 2025

(54) LARGE LANGUAGE MODELS (LLMS) CACHING VIA DOUBLE VERIFICATION

(71) Applicant: Cisco Technology, Inc., San Jose, CA (US)

(72) Inventors: Ali Payani, Cupertino, CA (US); Ramana Rao V.R. Kompella, Foster City, CA (US); Muthukumaran Ponnambalam, Union City, CA (US)

(73) Assignee: Cisco Technology, Inc., San Jose, CA (US)

(21) Appl. No.: 18/644,328

(22) Filed: Apr. 24, 2024

(51) Int. Cl. G06N 20/00

(52) U.S. Cl. CPC G06N 20/00

(57) ABSTRACT

A device obtains a particular query for input to a language model. The device identifies a plurality of cached query-response pairs whose queries are similar to that of the particular query. The device uses a verification model to assign joint probabilities between the particular query and responses from the plurality of cached query-response pairs. The device, based on the joint probabilities provides a particular response from the plurality of cached query-response pairs, in lieu of using the particular query as input to the language model to generate a new response.

### TECHNICAL FIELD

The present disclosure relates generally to large language models (LLMs) caching via double verification.

### BACKGROUND

The recent breakthroughs in large language models (LLMs), such as ChatGPT and GPT-4, represent new opportunities across a wide spectrum of industries. Indeed, the ability of these models to follow instructions now allow for interactions with tools (also called plugins) that are able to perform tasks such as searching the web, executing code, etc. In addition, LLMs are also able to interact with human users in a conversational manner to provide answers to highly technical and complex questions.

One of the drawbacks to LLMs is that their autoregressive natures can lead to delays in generating a response. This is because an LLM runs one feedforward pass for each token of the response. To aid in providing faster responses, recent efforts have shifted towards augmenting an LLM system with a caching mechanism that allows the system to first search a cache of existing query-answer pairs, only querying the LLM for answers to queries that do not match (or are sufficiently similar to) those stored in the cache. However, LLM caching today is not reliable as a simple modification of words in a given query can significantly change its meaning, even if it has a high semantic similarity to that of a query stored in the cache. In such a case, although the wording of the query is very similar to that of the cached one, the cached response will not satisfy the query sufficiently.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device;

FIG. 3 illustrates an example architecture for a large language model (LLM) caching via double verification;

FIG. 4 illustrates an example of the interactions of the components of the architecture in FIG. 3; and

FIG. 5 illustrates an example simplified procedure for LLM caching via double verification.

### DESCRIPTION OF EXAMPLE IMPLEMENTATIONS

### Overview

According to one or more implementations of the disclosure, a device obtains a particular query for input to a language model. The device identifies a plurality of cached query-response pairs whose queries are similar to that of the particular query. The device uses a verification model to assign joint probabilities between the particular query and responses from the plurality of cached query-response pairs. The device, based on the joint probabilities provides a particular response from the plurality of cached query-response pairs, in lieu of using the particular query as input to the language model to generate a new response.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

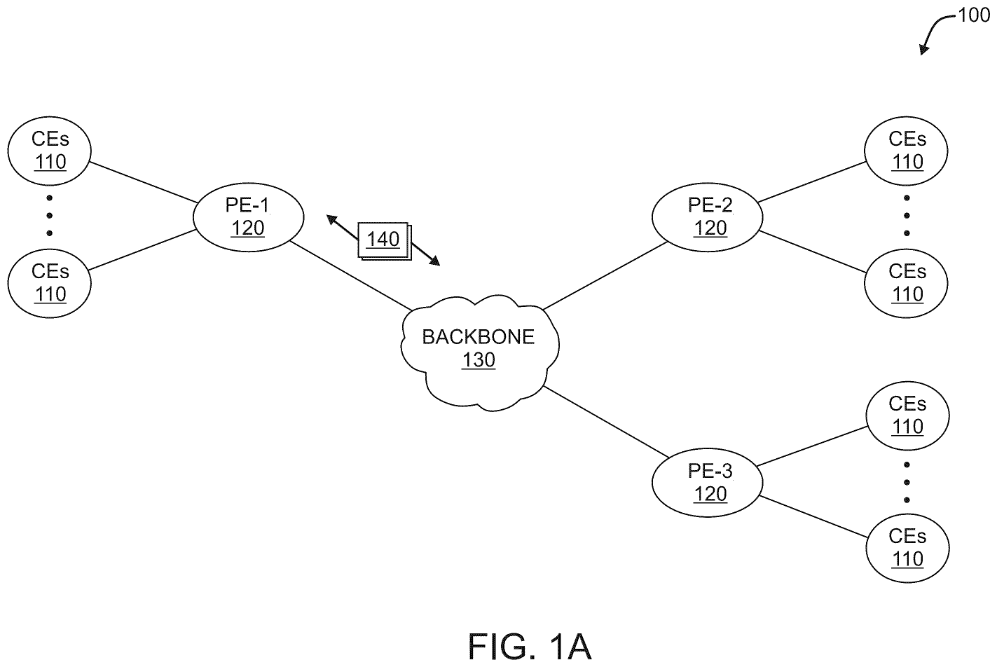

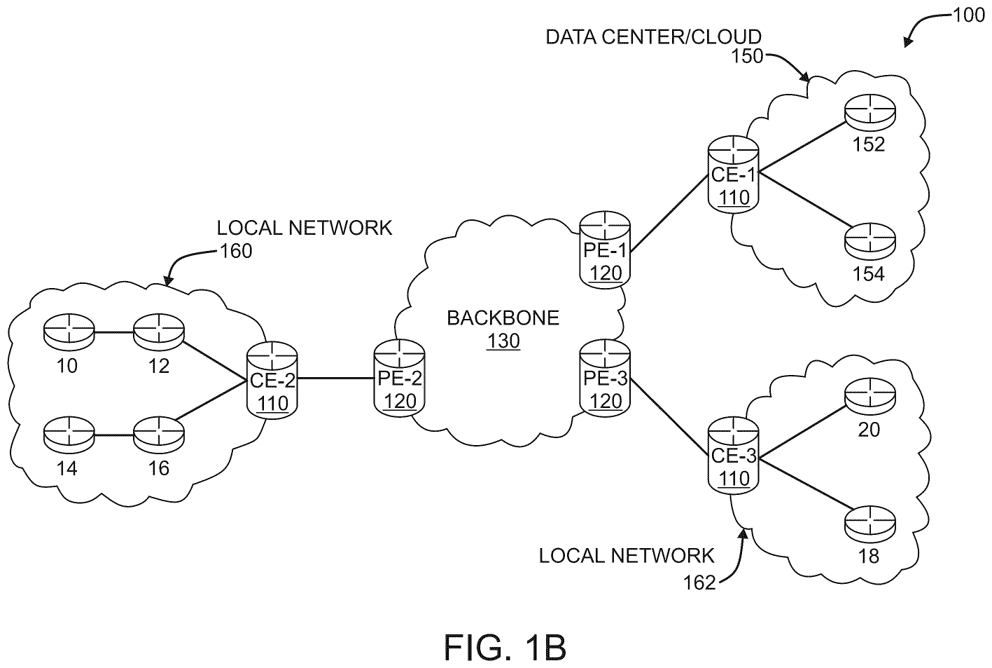

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

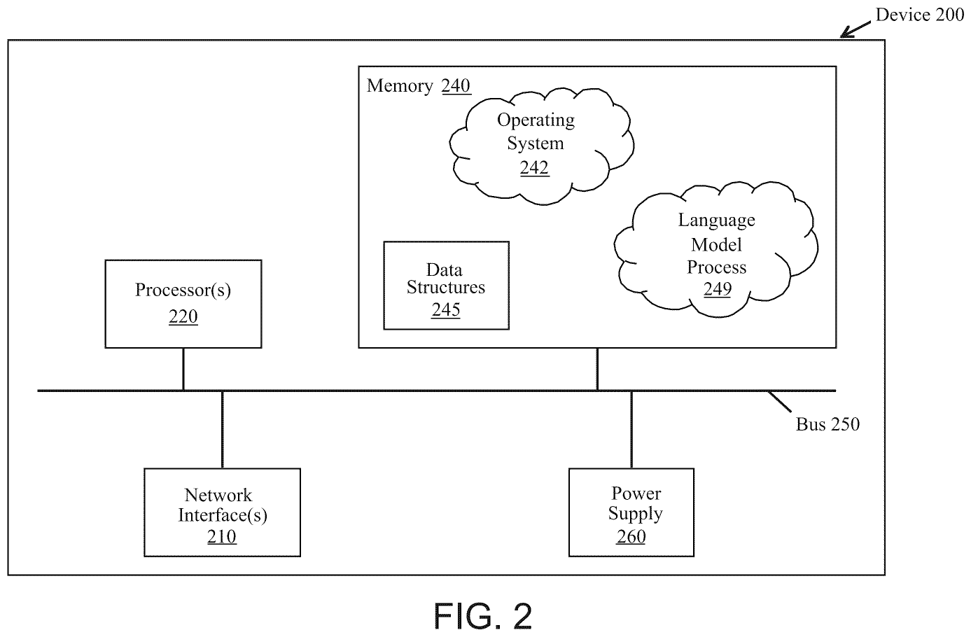

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. Device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

Network interfaces 210 include the mechanical, electrical, and signaling circuitry for communicating data over physical links coupled to network 100. Network interfaces 210 may be configured to transmit and/or receive data using a variety of different communication protocols. Notably, a physical network interface 210 may also be used to implement one or more virtual network interfaces, such as for virtual private network (VPN) access, known to those skilled in the art.

Memory 240 comprises a plurality of storage locations that are addressable by processor(s) 220 and network interfaces 210 for storing software programs and data structures associated with the implementations described herein. Processor 220 may comprise necessary elements or logic adapted to execute the software programs and manipulate data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a language model process 249 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, language model process 249 may include computer executable instructions that, when executed by processor(s) 220, cause device 200 to perform the techniques described herein. To do so, in some implementations, language model process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, language model process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that language model process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, language model process 249 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, language model process 249 may use a generative model to generate synthetic network traffic based on existing user traffic to test how the network reacts. Example generative approaches can include, but are not limited to, generative adversarial networks (GANs), large language models (LLMs), other transformer models, and the like.

As noted above, one challenge with respect to LLMs is that they are relatively slow when generating a response to a query due to their auto regressive nature. That is, they need to run one feedforward pass for each token, which is computationally costly, especially when generating long content.

One way to speed up the response of an LLM-based system is to implement semantic caching whereby prior query-response pairs are stored in a cache. Then, prior to sending a new query to the LLM, the system may look to see whether an input query is semantically similar to any of those in the cache. In such a case, rather than sending the input query on to the LLM to generate a new response, the system may simply return the response from the cache that is associated with the cached query that is semantically similar to the input query. However, this process can also be unreliable as the semantic similarity of two queries can be high, despite the two queries asking very different questions. When this happens, the caching mechanism will return a cached response that does not satisfy the input query, forcing the user to try again.

### LLM Caching Via Double Verification

The techniques herein help to improve false positive rate of current LLM caching approaches. In some aspects, the techniques herein leverage a verification model, to quickly assess whether a cached answer is suitable to answer an input query, despite its associated query in the cache having a high semantic similarity to that of the input query.

Illustratively, the techniques described herein may be performed by hardware, software, and/or firmware, such as in accordance with language model process 249, which may include computer executable instructions executed by the processor 220 (or independent processor of interfaces 210) to perform functions relating to the techniques described herein.

Specifically, according to various implementations, a device obtaining a particular query for input to a language model. The device identifies a plurality of cached query-response pairs whose queries are similar to that of the particular query. The device uses a verification model to assign joint probabilities between the particular query and responses from the plurality of cached query-response pairs. The device, based on the joint probabilities provides a particular response from the plurality of cached query-response pairs, in lieu of using the particular query as input to the language model to generate a new response.

Operationally, the techniques herein enhance the operations of an LLM caching mechanism through the use of double verification. More specifically, two observations are made herein with respect to semantic caching:
1.) As one adds more details to a query, the semantic similarity increases; and
2.) It is hard to find a reliable semantic similarity threshold.

For instance, a semantic similarity between queries “what is the distance between earth to sun?” and “what is the difference between mars to sun?” is 0.89. However, a semantic similarity between queries “what is the distance between earth to sun? please respond in KM” and “what is the difference between mars to sun? please respond in KM” is 0.91. Furthermore, semantic similarity between queries “can you answer this question? what is the distance between earth to sun? please respond in KM” and “can you answer this question? what is the difference between mars to sun? please respond in KM” is 0.92. Each of these three pairs of queries have different answers but they have a high semantic similarity. On the contrary, a semantic similarity between “who is the president of the United States?” and “can you please state the name of the president of US?” is only 0.84 even though these two queries are asking the same question in different forms. Thus, simple modifications of words in a query can significantly change its meaning, even though its semantic similarity remains arbitrary high with respect to a cached query.

The disclosure provides techniques where, for a particular query received from a user, mostly likely matches are picked from a query-response pairs cache. Then a LLM is used as a verifier to assign joint probability score to each of the most likely matches. A most suitable response for the query is then picked from the most likely matches based on the joint probability scores. Assigning joint probability allows filtering of reliable cache hits from unrelated ones cheaply, with very few forward passes and no need for autoregressive text generation.

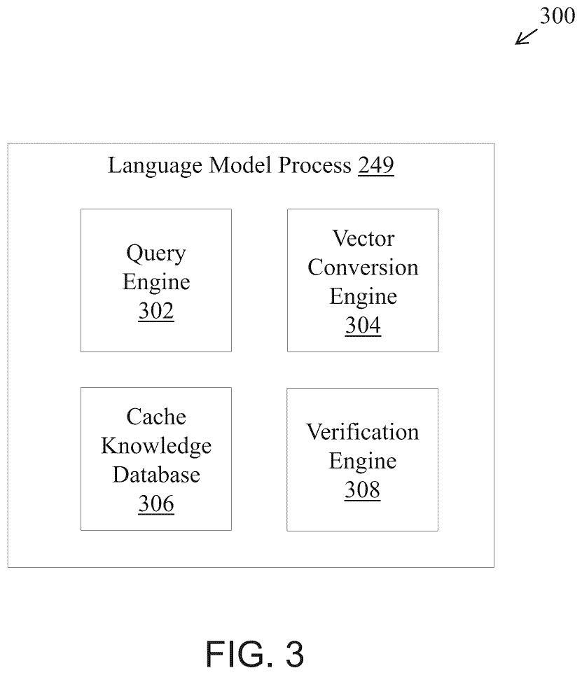

FIG. 3 illustrates an example architecture 300 for LLM caching via double verification, according to various implementations. At the core of architecture 300 is language model process 249, which may be executed at a user device, a CE router, a PE router, a server, or another device in communication with. Language model process 249 may interface with a user device, either locally or via a network, such as via one or more application programming interfaces (APIs), etc. In addition, language model process 249 may communicate with any number of user interfaces.

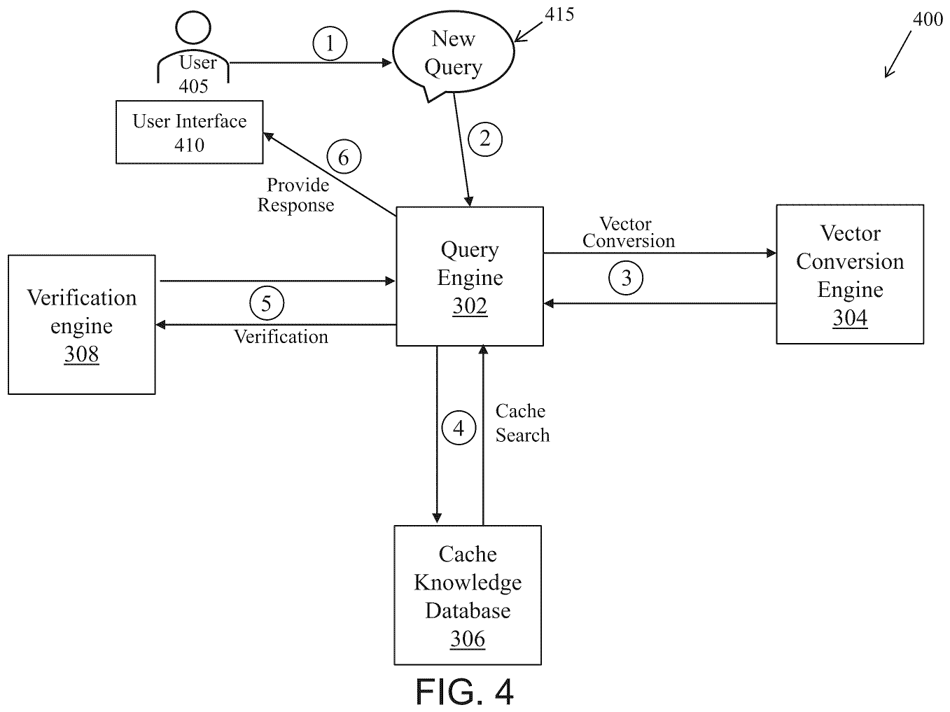

As shown, language model process 249 may include any or all of the following components: a query engine 302, a vector conversion engine 304, a cache knowledge database 306, and a verification engine 308. As would be appreciated, the functionalities of these components may be combined or omitted, as desired. In addition, these components may be implemented on a singular device or in a distributed manner, in which case the combination of executing devices can be viewed as their own singular device for purposes of executing language model process 249. FIG. 4 illustrates an example 400 of the interactions of the components of architecture 300.

According to various implementations, query engine 302 may receive a particular query from a user, run one or more steps that can include retrieving a response from a LLM cache or in calling an LLM for the response, and providing a response to the particular query. Thus, and as discussed in greater detail in the following sections of the disclosure, query engine 302 may leverage one or more LLMs and/or a query cache to provide a response to a particular query received from a user.

In various implementations, vector conversion engine 304 may convert the query received from the user in a natural language to a vector. Vector conversion engine 304 may use a variety of different embedding models to convert or to vectorize the query to a vector v1. Example embedding models include, but are not limited to, SBERT, OpenAI, or local open-source embedding models.

According to various implementations, cache knowledge database 306 may take the form of a vector database or other database that has the role of storing the text contents of queries as vector embeddings and a corresponding response to each query as a query-response pair. Cache knowledge database 306 may facilitate semantic searches of stored query-response pairs. In examples, cache knowledge database 306 may leverage a vector database such as Chroma or Pinecone to achieve this role, although other suitable databases could also be used as desired.

In various implementations, verification engine 308 may assign joint probabilities between the particular query and responses from the plurality of cached query-response pairs. The joint probability may be a likelihood of a cached response being a likely response for the particular query and is determined by comparing different continuations of the particular query and responses from the plurality of cached query-response pairs. Verification engine 308 may use another learning model to assign the joint probabilities. Assignment of the joint probabilities is discussed in greater detail in the following sections of the disclosure.

FIG. 4 illustrates an example 400 of the interactions of the components of the architecture in FIG. 3. As shown, a user 405 may create a new query 415 via a user interface 410, as shown at (1). New query 415 is sent from a user interface 410 to query engine 302, as shown at (2). New query 415 may be in a natural language, for example:
“What is the distance between earth to sun?”
“What is the status of a network device in network 100?”

Vector conversion engine 304 may convert the natural language query to an embedding vector. As discussed above, vector conversion engine 304 may use a variety of different embedding models to convert new query 415 to a vector. Regardless, 304//may query 415 is vectorized as:

$${e}_{s} = embed ( S )$$

where S is new query 415, and eₛ is an embedding vector corresponding to new query 415.

Query engine 302 may receive the vector eₛ corresponding to new query 415 from vector conversion engine 304, shown at (3). For each new query 415 (also referred to as Sn), query engine 302 performs a search in cache knowledge database 306, as shown at (4). One example method for performing the search is to compare the vector eₛ to vectors stored in cache knowledge database 306. During comparison, query engine 302 determines similar vectors stored in cache knowledge database 306 based on a semantic threshold.

For example, cache knowledge database 306 includes vectors corresponding to a plurality of query-response pairs stored in a LLM cache associated with a first LLM. In vector form, a jth query-response pair stored in a LLM cache is represented as:

$$V = \{ ( {e}_{j} , {s}_{j} , {r}_{j} ) \}$$

where:
Sⱼ is a query associated with the jth query-response pair;
eⱼ is a vector corresponding to the query associated with the jth query-response pair, and is determined as:

$${e}_{j} = embed ( {S}_{j} ) ,$$

and
rⱼ is a response received from the first LLM for the query associated with the jth query-response pair, and is determined as:

$${r}_{j} = LLM ( {S}_{j} ) .$$

The search in cache knowledge database 306 for the vector eₛ corresponding to new query 415 may yield:

$${e}^{*} = argmin cos ( {e}_{n} , {e}_{j} )$$

where e* is a cosine similarity or semantic similarity between the vector eₙ and a vector eⱼ. For example, and as discussed above, during searching, query engine 302 compares the vector eₙ to each vector stored in cache knowledge database 306 to determine a semantic similarity between the vector eₙ and each vector stored in cache knowledge database 306.

Query engine 302 may chose a predetermined number of top matches (also referred to as candidate matches) corresponding to the vector eₛ based on the semantic similarity. Query engine 302 then may determine the best match from the top matches through a verification process. For example, verification engine 308 determines or assigns a joint probability for each of the top matches. The joint probability is determined or assigned between new query 415 and responses from the plurality of cached query-response pairs. The joint probability is a likelihood of a particular response being a likely response to new query 415 and is determined by comparing different continuations of new query 415 and responses from the plurality of cached query-response pairs.

In an example scenario, a set C of the top matches are represented as:

$$C = ( {e}_{1}^{*} , {s}_{1}^{*} , {r}_{1}^{*} ) , … , ( {e}_{k}^{, *} , {s}_{k}^{*} , {r}_{k}^{*} ) .$$

For each of the top matches in the set C, verification engine 308 may determine the joint probability as:

$${P}_{i} = {P}_{lim} ( concat ( {s}_{n} , {r}_{i} ) )$$

where Pₗₗₘ is the joint probability of a likelihood of a continuation of a sequence of tokens represented by new query 415 and i^{th} response from an i^{th} query-response pair in the set C. The joint probability provides an indication of a likelihood of a particular response being a likely response to new query 415 based on comparing different continuations of new query 415 and responses from the plurality of cached query-response pairs. In an example implementation, the joint probability of P(concat (sₙ,r₁)) is greater than P(concat(sₙ,r₂)) if r₂ is more likely response to the query Sₙ.

Query engine 302 then may determine a particular triple (e*ᵢ, s*ᵢ, r*ᵢ) from the top matches with the highest Pᵢ as the match for new query 415. The particular response from the particular triple corresponding to the highest Pi is provided as the response to new query 415, as shown at (6).

The joint probability may be determined only using a forward pass and, therefore, is not a costly autoregressive generation. Hence, verification engine 308 may need at most k forward passes (where k is a number of predetermined top matches) for determining the best match from the top matches which is substantially lower cost compared to generating a response from the first LLM.

In some example implementations, verification engine 308 may also calculate a base joint probability (Pₛ) for new query 415. The base joint probability (Pₛ) represents no responses matching new query 415 in cache knowledge database 306. The base joint probability (Pₛ) is determined as:

$$Ps = {P}_{lim} ( {s}_{n} ) )$$

From the base joint probability, verification engine 308 may generate a normalized joint probability for each of the top matches in the set C of the top matches. The normalized probability is determined as:

$$\frac{Pi}{Ps}$$

where Pᵢ is the joint probability for i^{th} triple (e*ᵢ, s*ᵢ, r*ᵢ) in the set C. Query engine 302 then may determine a triple (e*ᵢ, s*ᵢ, r*ᵢ) from the top matches with the highest normalized joint probability as the match for new query 415.

In example implementations, verification engine 308 may leverage a second LLM (also referred to as a validation LLM or LLMv) for determining the joint probabilities between new query 415 and responses from the plurality of cached query-response pairs. Typically, this second LLM can be smaller than the first LLM. The second LLM is trained and fined tuned on common sense reasoning datasets including, but not limited to, CommonsenseQA, Situations With Adversarial Generations (SWAG), HellaSWAG, etc.

The goal of the second LLM is to compare different continuations, given the fact that the joint probability of P(concat (sₙ,r₁))>P(concat(sₙ,r₂)) if r₂ is more likely response to the query Sₙ. By training the second LLM, the cost of the verification process is reduced significantly.

In some implementations, verification engine 308 may discard a query-response pair from the top matches set if it is not a match. Discarding candidate matches may increase the efficiency of verification engine 308 and query engine 302. To do so, a binary classification head may be trained on top of the second LLM to classify each of the top matches as a match or a mismatch. The data for training the classification head can be obtained by the following example methods:
1)—by using common sense Question Answer (QA) datasets;
2)—by synthetically augmenting current QA datasets; and/or
3)—by collecting false/correct matches based on a user feedback (e.g., during inference when the system is in a testing phase).

In some instances, even using a smaller LLM can be costly. To address this, verification engine 308 could rely on a tree attention mechanism, to assess response candidates in parallel.

In some implementations, for each presented cache hit (response r), for query q, verification engine 308 or query engine 302 may obtain a user feedback in form of a thumbs down or a thumbs up from user 405 via user interface 410 (e.g., positive or negative feedback). The second LLM or a third LLM is trained based on the received user feedback by applying a linear probe to perform binary classification. That is, the second LLM or the third LLM may be trained as:

$$LLM\_probe ( q + r ) \to \{ 0 , 1 \} ,$$

where the training labels come from the positive and negative feedback for each presented cache hit.

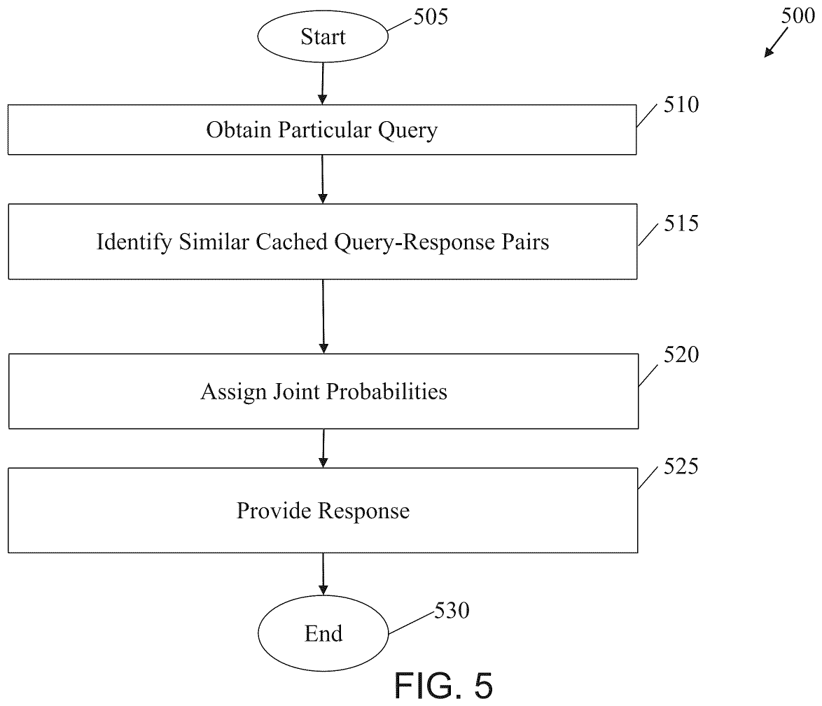

FIG. 5 illustrates an example simplified procedure (e.g., a method) 500 for LLM caching via double verification, in accordance with one or more implementations described herein. For example, a non-generic, specifically configured device (e.g., device 200), such as a router, firewall, controller for a network (e.g., an SDN controller or other device in communication therewith), server, or the like, may perform procedure 500 by executing stored instructions (e.g., language model process 249). The procedure 500 may start at step 505, and continues to step 510, where, as described in greater detail above, the device may receive a particular query (e.g., new query 415) from user 405.

At step 515, the device may identify a plurality of cached query-response pairs whose queries are similar to that of the particular query. As discussed above, a search is conducted in a LLM cache associated with an LLM for the particular query to determine a predetermined number of top matches, that is, cached query-response pairs whose queries are similar to that of the particular query. The top matches are determined based on a semantic similarity between the particular query and queries associated with query-response pairs in a LLM cache.

At step 520, the device may make assign joint probabilities between the particular query and responses from the plurality of cached query-response pairs. The joint probability may provide a likelihood of a cached response being a likely response for the particular query and is determined by comparing different continuations of the particular query and responses from the plurality of cached query-response pairs. As discussed above, a second LLM is used to assign the joint probabilities between the particular query and responses from the plurality of cached query-response pairs.

At step 525, the device and based on the joint probabilities, a particular response from the plurality of cached query-response pairs, is provided in lieu of using the particular query as input to the language model to generate a new response. For example, as discussed above a response with the highest joint probability between the particular query and responses from the plurality of cached query-response pairs is provided as the response to the particular query.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for LLM caching via double verification, it is to be understood that various other adaptations and modifications may be made within the spirit and scope of the implementations herein. For example, while certain implementations are described herein with respect to using certain models for purposes of generating CLI commands, making API calls, charting a network, and the like, the models are not limited as such and may be used for other types of predictions, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method comprising:
obtaining, by a device, a particular query for input to a language model;
identifying, by the device, a plurality of cached query-response pairs whose queries are similar to that of the particular query;
using, by the device, a verification model to assign joint probabilities between the particular query and responses from the plurality of cached query-response pairs; and
providing, by the device and based on the joint probabilities, a particular response from the plurality of cached query-response pairs, in lieu of using the particular query as input to the language model to generate a new response.

2. The method as in claim 1, further comprising:
assigning a joint probability between the particular query and a response from each of the plurality of cached query-response pairs based on a likelihood of the response being a likely response to the particular query.

3. The method as in claim 1, further comprising:
classifying each response from the plurality of cached query-response pairs as a match or a mismatch.

4. The method as in claim 1, further comprising:
training another language model to classifying each response from the plurality of cached query-response pairs as a match or a mismatch.

5. The method as in claim 1, further comprising:
providing the particular response to a user;
receiving a feedback from the user, the feedback comprising whether the particular response is a match or a mismatch to the particular query; and
training, based on the feedback, another language model to classify each response from the plurality of cached query-response pairs as a match or a mismatch.

6. The method as in claim 1, wherein the plurality of cached query-response pairs comprises a predetermined number of top matches to the particular query.

7. The method as in claim 1, wherein the verification model comprises a second language model, wherein the second language model is smaller than the language model.

8. The method of claim 1, wherein the joint probabilities between the particular query and the responses from the plurality of cached query-response pairs are assigned based on comparing different continuations of the particular query and the responses.

9. The method as in claim 1, wherein the particular response is associated with a highest joint probability.

10. The method as in claim 1, wherein the particular query comprises a status of a device in a computer network.

11. An apparatus, comprising:
one or more network interfaces;
a processor coupled to the one or more network interfaces and configured to execute one or more processes; and
a memory configured to store a process that is executable by the processor, the process when executed configured to:
obtain a particular query for input to a language model;
identify a plurality of cached query-response pairs whose queries are similar to that of the particular query;
use a verification model to assign joint probabilities between the particular query and responses from the plurality of cached query-response pairs; and
provide, based on the joint probabilities, a particular response from the plurality of cached query-response pairs, in lieu of using the particular query as input to the language model to generate a new response.

12. The apparatus as in claim 11, wherein process when executed is further configured to:
assign a joint probability between the particular query and a response from each of the plurality of cached query-response pairs based on a likelihood of the response being a likely response to the particular query.

13. The apparatus as in claim 11, wherein process when executed is further configured to:
classify each response from the plurality of cached query-response pairs as a match or a mismatch.

14. The apparatus as in claim 11, wherein process when executed is further configured to:
train another language model to classifying each response from the plurality of cached query-response pairs as a match or a mismatch.

15. The apparatus as in claim 11, wherein the process when executed being configured to:
provide the particular response to a user;
receive a feedback from the user, the feedback comprising whether the particular response is a match or a mismatch to the particular query; and
train, based on the feedback, another language model to classify each response from the plurality of cached query-response pairs as a match or a mismatch.

16. The apparatus as in claim 11, wherein the plurality of cached query-response pairs comprises a predetermined number of top matches to the particular query.

17. The apparatus as in claim 11, wherein the verification model comprises a second language model, wherein the second language model is smaller than the language model.

18. The apparatus as in claim 11, wherein the joint probabilities between the particular query and the responses from the plurality of cached query-response pairs are assigned based on comparing different continuations of the particular query and the responses.

19. The apparatus as in claim 11, wherein the particular response is associated with a highest joint probability.

20. A tangible, non-transitory, computer-readable medium storing program instructions that cause a device to execute a process comprising:
obtaining, by a device, a particular query for input to a language model;
identifying, by the device, a plurality of cached query-response pairs whose queries are similar to that of the particular query;
using, by the device, a verification model to assign joint probabilities between the particular query and responses from the plurality of cached query-response pairs; and
providing, by the device and based on the joint probabilities, a particular response from the plurality of cached query-response pairs, in lieu of using the particular query as input to the language model to generate a new response.
